(19) United States
(12) Patent Application Publication
(10) Pub. No.: US 2005/0180375 A1
(43) Pub. Date: Aug. 18, 2005

(54) System and method for channelization and data multiplexing in a wireless communication network

(76) Inventors: Anuj Batra, Dallas, TX (US); Jaiganesh Balakrishnan, Dallas, TX (US); Anand Dabak, Plano, TX (US); Nathan Belk, Lucas, TX (US); Danielle Griffith, Richardson, TX (US)

Correspondence Address: TEXAS INSTRUMENTS INCORPORATED, P O BOX 655474, M/S 3999, DALLAS, TX, 75265, US

(21) Appl. No.: 11/032,402

(22) Filed: Jan. 10, 2005

Related U.S. Application Data
(60) Provisional application No. 60/535,305, filed on Jan. 9, 2004.
(60) Provisional application No. 60/550,938, filed on Mar. 4, 2004.

(51) Int. Cl. H04B 7/208

(52) U.S. Cl. 370/344

(57) ABSTRACT

A system and method for channelization and data multiplexing in ultra-wideband (UWB) wireless communication system is described. The spectrum allocated for UWB in a multi-band OFDM (orthogonal frequency division multiplex) system is subdivided into various bands. A set of time frequency codes (TFC's) is defined, wherein each code specifies one of a plurality of unique band versus time sequences for a particular band group, for sequential data symbols of a given piconet. The separation of data words from multiple devices or multiple simultaneously operating piconets (SOP's) is provided by a combination of FDMA and TFC's. The combination of FDMA and TFC's provides a simplified interface between the MAC and PHY.

### CROSS-REFERENCE TO RELATED APPLICATIONS

This application is related to and claims priority from U.S. Provisional Patent Application Ser. No. 60/535,305 filed on Jan. 09, 2004 and U.S. Provisional Patent Application Ser. No. 60/550,938 filed on Mar. 04, 2004. Disclosures of these applications are incorporated herein by references in their entirety for all purposes.

### BACKGROUND

1. Field of the Invention

The present invention relates to ultra-wideband (UWB) wireless communication systems in general, and, in particular, to channelization and data multiplexing in multi-band orthogonal frequency division multiplexing (OFDM) systems.

2. Description of the Related Art

Unlicensed wireless data communications systems such as Wi-Fi (IEEE 802.11b, 802.11g) have found wide acceptance, connecting PC's and digital appliances such as digital cameras, video cameras, and PDA's to each other and to internet gateways. Performance of wireless systems is typically affected by choice of frequency, bandwidth, modulation type, data multiplexing type, data rate, and power level. Design tradeoffs considering these parameters have a significant impact on the complexity of hardware and software, and can affect cost, size, and power consumption. It is generally desirable to maximize data rates, number of simultaneous users, and range, while minimizing transmit power and hardware complexity.

A type of wireless system, ultra-wideband (UWB), has an occupied bandwidth much wider than many traditional systems. The spectrum allocated in the United States for UWB is from 3,100 MHz to 10,600 MHz (7,500 MHz bandwidth); contrast this with the 20 MHz bandwidth allocated for US commercial FM broadcasting. Wireless communication systems using UWB technology typically provide multiple time division duplex (TDD) data sessions among users or devices. Data multiplexing provides shared access to the communication system for multiple users or devices. Widely used forms of multiplexing include frequency division multiple access (FDMA), where signals or data streams are each modulated onto unique portions of spectrum, and time division multiple access (TDMA), where data packets from different users or devices are assigned unique time slots in the same portion of spectrum.

A known art approach to data multiplexing in a UWB system uses code division multiple access (CDMA), a direct-sequence spread-spectrum system also used in cellular telephony, wireless LAN, and many other applications. CDMA first modifies the user data to be transmitted by multiplying it with a unique pseudo-noise (PN) spreading code having a bit width typically 5 to 20 times narrower (in time) than the user data bit width. The resultant digital signal, now at a much higher chip rate than the original data rate, is modulated onto a radio-frequency (RF) carrier. The high data rate of the PN code, compared to the user data rate, spreads the coded information across a much wider portion of spectrum. Each user or device is given a unique spreading code to differentiate its data stream from other users or devices data streams. At the receiver, the original data is recovered by de-spreading using this unique PN code.

CDMA systems with bandwidth in the GHz range pose stringent demands on transmit and receive hardware, which are generally difficult and costly to meet. Wideband UWB CDMA typically requires very high speed RF and analog circuits, as well as very high speed analog to digital (A/D) and digital to analog (D/A) converters. Complex digital circuitry is required to capture sufficient multipath energy to provide acceptable link range. CDMA also increases the probability of interference from one device to another as the number of devices in the shared spectrum increases.

Some wireless communications systems are designed to support simultaneous data transmission among multiple devices and multiple groups of devices. A group or network of devices having data connection among each other is sometimes referred to as a piconet. A piconet is a logical group of two or more devices communicating with each other, without interference from other piconets even in close proximity. An example piconet might be a digital camera with UWB connection to a PC, downloading images to the PC. Another might be a DVD player with a UWB wireless link to a television display.

In UWB systems it is often advantageous to support as many simultaneously operating piconets (SOP's) as possible. Multiple SOP's typically require that data packets or symbols from devices on each SOP are multiplexed in a manner so data packets from one SOP are not readable to other SOP's. While known UWB multiplexing schemes support multiple SOP's, an alternative channelization and multiplexing scheme increasing the number of SOP's would be beneficial.

The choice of channelization and multiplexing also impacts the logical connection between the medium access controller (MAC) and the physical layer (PHY). The MAC assigns a unique data path to each of the data streams or piconets. These data paths are then mapped, in the PHY, to the physical characteristics necessary to affect minimally interfering multiplexing of the data. These characteristics might include spreading code in a CDMA system, frequency in a FDMA system, time slot in a TDMA system, or some combination thereof. It is desirable to simplify the interface between the MAC and the PHY.

### SUMMARY

The present application describes a system and method for channelization of spectrum and multiplexing of data in a multi-band OFDM wireless communication system, providing improved support of multiple SOP's, and providing a simplified interface between the MAC and the PHY. The UWB spectrum (3,100 MHz to 10,600 MHz) is subdivided into bands 528 MHz wide, which are then grouped into band groups each having two or more adjacent bands. User data is modulated onto a plurality (typically 100) of OFDM data tones in one of the 528 MHz bands, and the band used to transmit the OFDM symbols for a given piconet changes with time in a defined sequence. Within each band group, the sequence of bands used for a particular piconet is defined by a time-frequency code (TFC). The method provides a combination of FDMA and time-frequency codes, enabling support of a larger number of SOP's. Additional advantages over known art include the ability to tailor the frequency bands to specific regions or countries to mitigate interference with existing wireless services, and the separation of types of service by frequency, allowing optimization of bands used for given data rate and range requirements.

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways, and such changes and modifications may be made without departing from this invention and its broader aspects. Other aspects, inventive features, and advantages of the present invention, as defined solely by the claims, will become apparent in the non-limiting detailed description set forth below.

### BRIEF DESCRIPTION OF THE DRAWINGS

FIG. 1 is a chart of a multi-band OFDM band plan from 3.1 GHz to 10.6 GHz, detailing frequencies of bands and groupings of 3 or 4 bands into each of 4 band groups;

FIG. 2 is a chart showing the mapping between time-frequency codes (TFC's), band groups, and preamble patterns, for the band plan of FIG. 1;

FIG. 3 is a chart of another embodiment of a multi-band OFDM band plan from 3.1 GHz to 10.6, detailing frequencies of bands and groupings of 2 or 3 bands into each of 5 band groups;

FIG. 4 is a chart showing the mapping between time-frequency codes (TFC's), band groups, and preamble patterns, for the band plan of FIG. 3;

FIG. 5 is a chart of yet another embodiment of a multi-band OFDM band plan from 3.1 GHz to 10.6 GHz, detailing frequencies of bands and groupings of 2 or 3 bands into each of 5 band groups;

FIG. 6 is a chart showing the mapping between time-frequency codes (TFC's), band groups, and preamble patterns, for the band plan of FIG. 5;

FIG. 7 is a table describing how a frequency synthesizer can generate the center frequencies of all bands in the band plan of FIG. 5;

FIG. 8 is a block diagram of a data transmitter using band groups and time varying frequency bands (controlled by time frequency codes), to separate and multiplex a plurality of data streams from unique users, devices, or piconets.

### DESCRIPTION OF THE PREFERRED EMBODIMENT(S)

The description that follows presents a series of systems, apparati, methods and techniques that facilitate additional local register storage through the use of a virtual register set in a processor. While much of the description herein assumes a single processor, process or thread context, some realizations in accordance with the present invention provide expanded internal register capability customizable for each processor of a multiprocessor, each process and/or each thread of execution. Accordingly, in view of the above, and without limitation, certain exemplary exploitations are now described.

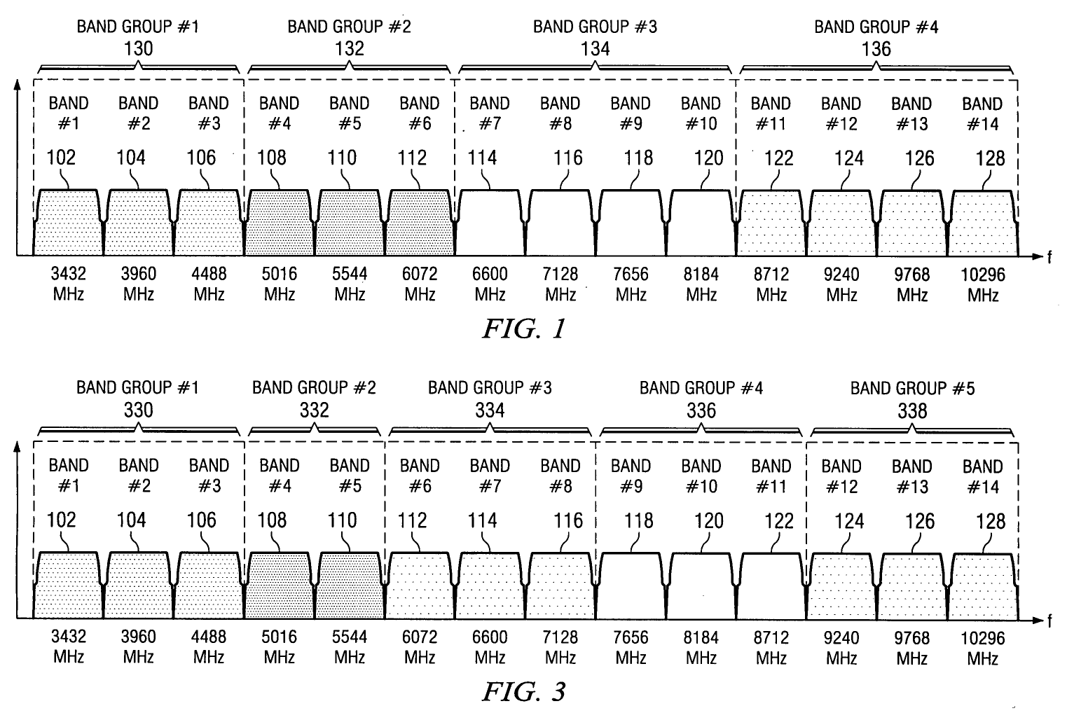

FIG. 1, a band plan for multi-band OFDM details fourteen bands (102-128), each 528 MHz wide, in the spectral range 3.1 GHz to 10.6 GHz. These bands are further grouped into four band groups. The first band group, band group 1 (130) includes bands 102, 104, 106; band group 2 (132) includes bands 108, 110, 112; band group 3 (134) includes bands 114, 116, 118, 120; band group 4 (136) includes bands 122, 124, 126, 128. The center frequencies of each band are given by the formula:
FC(N)=3432+528* (N-1) MHZ
where FC(N) is the center frequency of band N.

Coded bits are aggregated into groups of typically 100 or 200 bits each. Pairs of bits within the group are modulated, using known modulation techniques such as quadrature phase shift keying (QPSK), onto typically 100 data tones generally equally spaced in one of the 528 MHz bands. Symbols associated with a unique piconet are assigned a specific one of the 4 band groups, and are further assigned a unique time-frequency code (TFC) within the assigned band group. The band assigned for successive symbols changes with time according to a time frequency code.

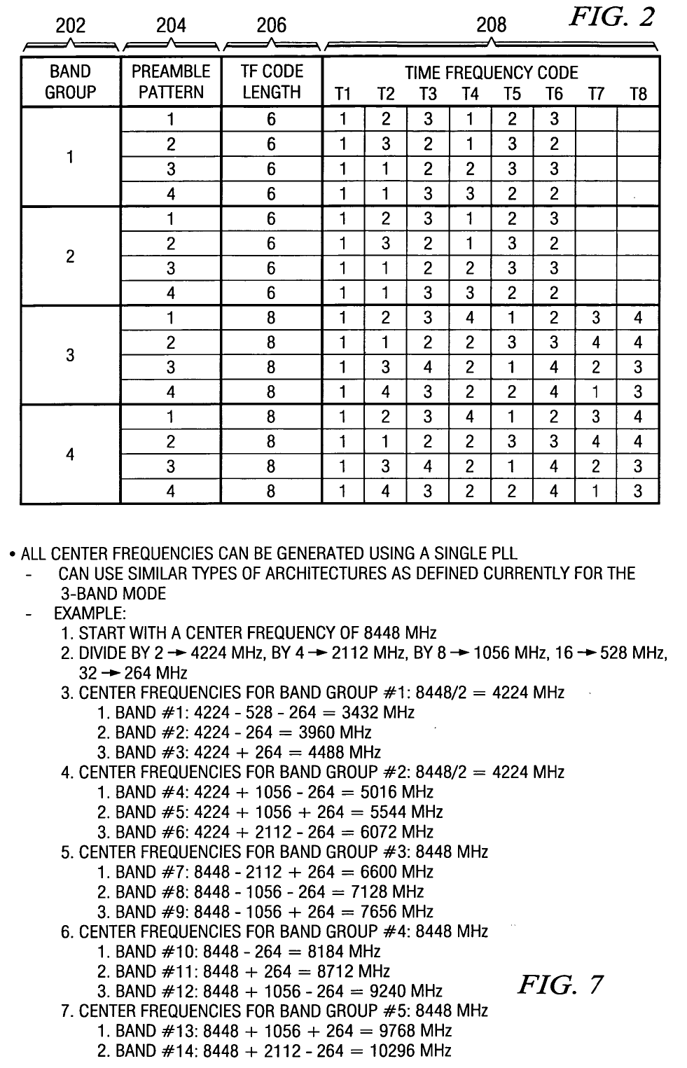

FIG. 2 is a table showing the mapping of time frequency codes 208 and preambles 204 to band groups 202 for the band plan of FIG. 1. Examining band group 1, for example, there are 4 preamble patterns, each for a unique piconet, device or user which may have sole or shared access to the band group. A preamble is a set of data bits appended to each packet by the MAC, and aids in packet detection, synchronization, and timing/frequency estimation. Associated with each preamble pattern 204 is a unique time frequency code sequence 208. The length of each time frequency (TF) code sequence is given by the TF Code Length 206. This TFC sequence specifies the band to be used for each successive symbol, repeating after six symbols (in the case of band group 1 and 2) or eight symbols (in the case of band group 3 and 4).

Examining band group 1 for example, four simultaneously operating piconets (SOP's) are each assigned a unique preamble pattern (hence a unique sequence of TFC's). Each piconet can access the channel with statistically acceptable interference from other piconets. The TFC's are chosen to minimize interference caused by more than one device transmitting in the same band at the same time. When all TFC's of FIG. 2 are in use, over the 6-symbol repeat period, interference to a particular piconet or device is typically present on average ⅓ of the time. Interference is mitigated through the use of error correcting coding of the data within the symbols and repetitive transmission of data, as commonly used in other impaired communication channels.

This combination of FDMA, splitting the assigned bandwidth into 4 band groups further subdivided into 16 bands, and time-frequency coding provides, in each band group, operation of up to 4 devices or SOP's. Using all 4 band groups, up to 16 SOP's or devices can simultaneously communicate in the assigned spectrum. Each of the sixteen possible combinations is uniquely described by combining the band group number and the preamble pattern number. This simplifies the interface between the MAC, which assigns one of the sixteen possible data paths to a user, and the PHY.

FIG. 3 charts an alternative band plan comprising 5 band groups and 14 bands. This alternative embodiment demonstrates that the band group having 2 bands can be strategically placed, for example to avoid using a portion of spectrum known to have high levels of interference, or to avoid causing interference to existing users of that spectrum. By so placing this 2-band band group, only 2 bands are lost if the band group is unusable. The channelization of FIG. 3 is as follows: Band group 1 (330) includes bands 102, 104, 106; band group 2 (332) includes bands 108, 110; band group 3 (334) includes bands 112, 114, 116; band group 4(336) includes bands 118, 120, 122; and band group 5 (338) includes bands 124, 126, 128.

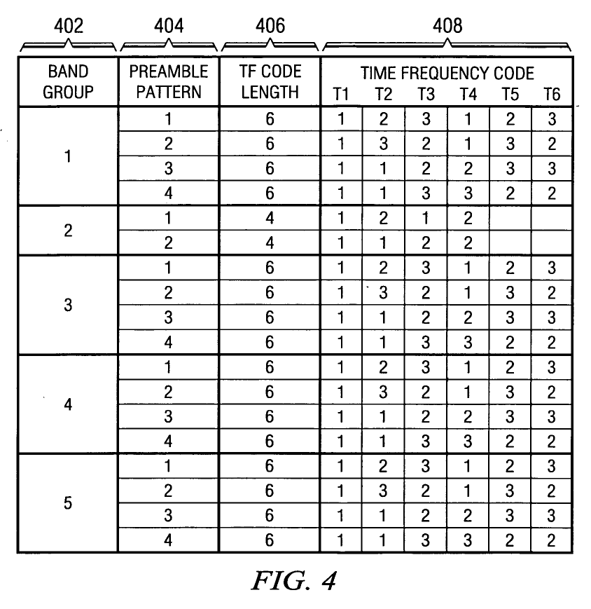

FIG. 4 shows a table of time frequency codes 408 associated with each band group 402, as well as preamble pattern numbers 404, for the band plan of FIG. 3. Examining band group 1, for example, there are 4 preamble patterns 404, each representing a unique piconet, device or user which may have sole or shared access to the band group. Associated with each preamble pattern is a unique time frequency code sequence 408. The length of each time frequency (TF) code sequence is given by the TF Code Length 406. This TFC sequence specifies the band to be used for each successive data symbol, repeating after six symbols. Note that, like the band plan shown in FIG. 1, band groups having 3 bands have 4 unique preambles hence 4 unique TFC's; band group 2 however has only 2 bands and thus only 2 TFC's. Other aspects of operation of this embodiment are the same as the embodiment of FIGS. 1 and 2.

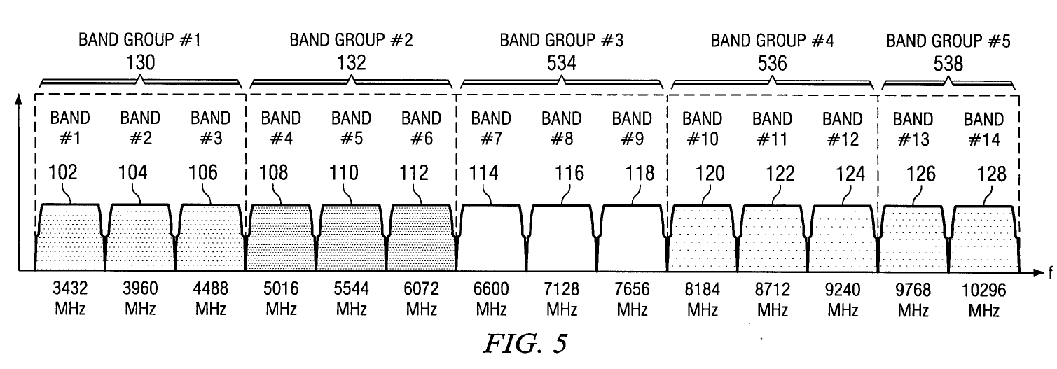

FIG. 5 is a chart showing yet another band plan. This plan has several advantage over the band plans of FIGS. 1 and 3. Path loss at lower frequencies is less than at higher frequencies, making the lower bands typically preferred. Some hardware implementations of UWB PHY use only one band group, (typically the lowest 130), while other PHY implementations use multiple band groups. The design of a PHY supporting multiple band groups is significantly simplified by the fact that band groups 1 through 4 all have the same bandwidth. Therefore, the PHY transmitter or receiver can tune to any of the first 4 band groups by simply changing a local oscillator frequency. Common filtering and processing before upconversion (transmitter) or after downconverion (receiver) is applied to a 528 MHz wide band regardless of band group chosen, reducing circuit complexity. Band group 1 (130) includes bands 102, 104, 106; band group 2 (132) includes bands 108, 110, 112; band group 3 (534) includes bands 114, 116, 118; band group 4 (536) includes bands 120, 122, 124; and band group 5 (538) includes bands 126, 128.

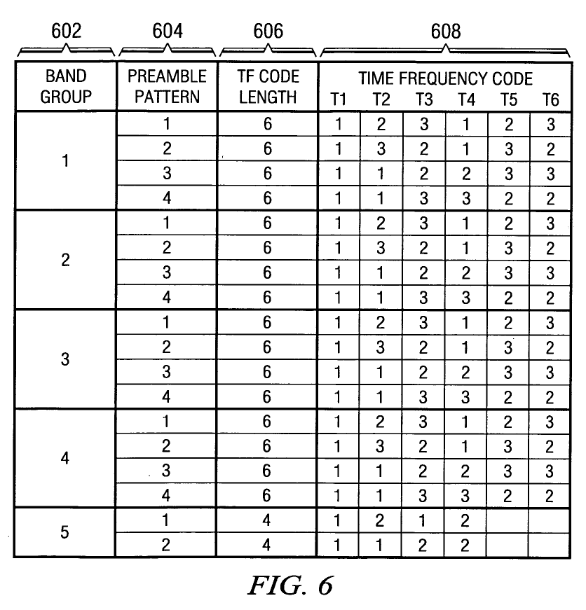

FIG. 6 is a table of preamble patterns 604 and time frequency codes 608 for each band group 602 of the band plan of FIG. 5. The length of each time frequency (TF) code sequence is given by the TF Code Length 606. The time frequency code length (repeat interval) in all cases is 6 symbols. Band groups 1 through 4 each have 3 bands and 4 unique preamble patterns, each thus having 4 unique TFC's. Band group 5 has 2 bands and 2 unique preamble patterns, each thus having 2 unique TFC's. The combination of 5 band groups and 4 preamble patterns (TFC's) supports up to 18 devices or SOP's. Alternative embodiments might use different TFC sequences, even those statistically more prone to interference from others sharing the band group; might divide the allocated spectrum into larger or smaller segments; might group more or fewer bands into each band group; or might use other slight differences while retaining the advantages of combining FDMA and time frequency codes.

FIG. 7 is a chart showing how the center frequencies for each band of the band plan of FIG. 5 can be synthesized. Starting with a signal at 8448 MHz, repeated division by 2 provides a plurality of reference signals at 4224 MHz, 2112 MHz, 1056 MHz, 528 MHz, and 264 MHz. By adding or subtracting at most 3 of these reference signals, signals at the center frequency of all 14 bands are generated. The hardware implementation of such a synthesizer can be done in a variety of known ways.

FIG. 8 is a block diagram of one embodiment using the channelization and time frequency codes described above. User data at Input Data 802 from a unique user or device or piconet is input to Scrambler 804, which, using known techniques, encrypts the data to secure it. Convolutional coding is then applied to the data by Convolutional Encoder 806, to facilitate error detection and correction at the receiver. The data is then further modified by puncturing (removing certain bits from the data packets) in Puncturer 808. Bit interleaving of the data is then applied in Bit Interleaver 810, to spread (in time) bits from a given user data packet over a plurality of OFDM symbols. The output of Bit Interleaver 810 is a sequence of typically 200-bit (or 100-bit, depending on input data rate) data symbols. These symbols are applied to Constellation Mapping 812, which assigns to each N-bit data segment a unique tone frequency and unique point in the modulation constellation for that tone. For example, QPSK modulation has a 4-point constellation, and each 2-bit data segment is mapped to one of the 4 points. Data then flows to the Inverse Fast Fourier Transform (IFFT) circuit 814, where pilot tones data and other ancillary data is added. The IFFT then converts data describing the frequency domain characteristics of the signal to data describing the time domain characteristics of the signal. The time domain data from IFFT 814 is then applied to Digital to Analog Converter (DAC) for conversion to an analog signal.

This baseband analog signal out of DAC 816 thus has user data QPSK modulated onto 100 tones spaced at 4.125 MHz, plus 28 guard, pilot and null tones, also at 4.125 MHz spacing, creating a baseband OFDM signal in the 0 to 528 MHz range at the output of DAC 816. The baseband OFDM signal from DAC 816 is input to one input of multiplier 818. The other input of multiplier 818 is a band center frequency signal from synthesized generator 820. The output of multiplier 818 is the sum of the generator 820 frequency and the baseband input from DAC 816. The baseband OFDM signal is thus upconverted to one of the 14 bands of (for example) FIG. 5, and is output at antenna 824.

Synthesized generator 820 typically uses addition or subtraction of a plurality of reference signals to create one of a multiplicity of frequencies, as shown in FIG. 7. The frequency of generator 820, thus which of the 14 bands is used for a given data symbol, is controlled by frequency control data from a time frequency code (TFC) sequence generator referred to as Time-Frequency Kernel 822.

The Time-Frequency Kernel 822 has as its inputs a preamble number and a band group number from the MAC (medium access controller), which preamble and band group, in combination, are unique to a specific piconet, user or device inputting data to input 802. An example of mapping from band group and preamble to TFC is shown in FIG. 6. Successive user data symbols are transmitted sequentially in all the bands (for example, bands 102, 104, 106 of band group 130 in FIG. 5) of the assigned band group. The unique time sequence of bands for a given user is determined by a table mapping the combination of band group number and preamble pattern number to a time frequency code, which (as shown in FIG. 6) is a repeating series of band numbers for the band group. Data from multiple users, devices or SOP's is thus separated by frequency (FDMA), as each user, device or SOP is assigned a band group, and is further assigned a time-varying band (by the TFC) to use within that assigned band group.

The example embodiments described in the figures and accompanying descriptions show that variations in band group and band definitions, TFC structure, or modulation technique can all be made, while retaining the advantages of combining frequency division multiple access (FDMA) and time frequency codes (TFC). Those skilled in the art to which the invention relates will appreciate that yet other substitutions and modifications can be made to the described embodiments, without departing from the spirit and scope of the invention as described by the claims below. For example, the combination of frequency bands with a band group can be reconfigured to minimize interference among pico nets within a given physical environment. Similarly, various combinations of band groups can be formed according to a quality of data throughput required in given wireless network.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the exemplary configurations may be implemented as a combined structure or component. These and other variations, modifications, additions, and improvements may fall within the scope of the invention as defined in the claims that follow.

1. A method of communication in a wireless network using ultra-wideband (UWB) spectrum, the wireless network comprising one or more simultaneously operating pico networks, the method comprising:
dividing the UWB spectrum into a plurality of frequency bands;
forming one or more band groups including one or more frequency bands;
assigning at least one band group to each one of the pico networks;
assigning at least one time frequency code to symbols associated with each one of the pico networks, wherein the time frequency code represents one of a single frequency band and a pre-defined sequencing across all the frequency bands within the assigned band group;
communicating data within each one of the pico networks using the assigned band groups according to the time frequency code.

2. A method according to claim 1, wherein each frequency band is 528 MHz wide.

3. A method according to claim 2, wherein a center frequency of each frequency band is given by:
FC(N)=3432+528*(N-1) MHz,
wherein FC(N) is the center frequency of band N.

4. A method according to claim 1, further comprising:
changing the assigned frequency band for successive symbols within each pico network according to the time frequency code.

5. A method according to claim 1, further comprising:
assigning a preamble to each one of the pico networks.

6. A method according to claim 3, wherein
the UWB spectrum includes at most fourteen frequency bands.

7. A method according to claim 6, wherein
the UWB spectrum comprises at least two band groups each including at least three frequency bands, and at least two band groups each including at least four frequency bands.

8. A method according to claim 6, wherein
the UWB spectrum comprises at least four band groups each including at least three frequency bands, and at least one band group including at least two frequency bands.

9. A method according to claim 8, wherein the band group including the at least two frequency bands is placed in a high interference portion of the UWB spectrum.

10. A method according to claim 8, wherein the band group including the at least two frequency bands is placed above 9500 MHz in the UWB spectrum.

11. A method according to claim 8, wherein the band group including the at least two frequency bands is placed above 4750 MHz in the UWB spectrum.

12. A system for channelization of ultra-wideband (UWB) spectrum in a wireless network using ultra-wideband (UWB) spectrum, the wireless network comprising one or more simultaneously operating pico networks, the system comprising
a frequency-synthesized oscillator configured to generate a signal in steps of 528 MHz beginning at center frequency of 3432 MHz and ending at center frequency of 10,296 MHz; and
a time frequency code generator coupled to the frequency-synthesized oscillator and configured to assign time-frequency codes to successive data symbols of a pico network such that the successive data symbols are transmitted in all frequency bands of a band group assigned to the pico network.

13. A system according to claim 12, wherein the time frequency generator assigns the time-frequency codes to the data symbols according to a preamble number and a band group number assigned to the corresponding pico network.

14. A system according to claim 12, wherein
the UWB spectrum comprises at least two band groups each including at least three frequency bands, and at least two band groups each including at least four frequency bands.

15. A system according to claim 12, wherein
the UWB spectrum comprises at least four band groups each including at least three frequency bands, and at least one band group including at least two frequency bands.

16. A system according to claim 15, wherein the band group including the at least two frequency bands is placed in a high interference portion of the UWB spectrum.

17. A system according to claim 15, wherein the band group including the at least two frequency bands is placed above 9500 MHz in the UWB spectrum.

18. A system according to claim 15, wherein the band group including the at least two frequency bands is placed above 4750 MHz in the UWB spectrum.

19. A system according to claim 12, further comprising:
a data coding circuit coupled to the frequency-synthesized oscillator and configured to add convolutional error correcting codes to incoming data symbol, interleave across at most 1200 coded data bits and map onto data symbols;
an OFDM (orthogonal frequency division multiplex) modulator coupled to the data coding circuit and configured to modulate the at most 100 data symbols onto at most 110 tones at 4.125 MHz spacing to create a baseband OFDM signal from DC to 528 MHz; and
a frequency multiplier coupled to the frequency-synthesized oscillator and configured to frequency shift the baseband OFDM signal one of the frequency bands.
